(19) United States
(12) Patent Application Publication
(10) Pub. No.: US 2009/0286489 A1
(43) Pub. Date: Nov. 19, 2009

(54) Wireless Communications Between Wired Devices with Adaptive Data Rates

(75) Inventors: Venkatagopal Racherla, San Diego, CA (US); Stephan Walter Gehring, Staefa (CH); Daniel Paul Peters, Carlsbad, CA (US); Arul Kumar Subbiah, Santa Clara, CA (US)

Correspondence Address: FITCH EVEN TABIN & FLANNERY, 120 SOUTH LASALLE STREET, SUITE 1600, CHICAGO, IL, 60603-3406, US

(73) Assignee: General Atomics, San Diego, CA (US)

(21) Appl. No.: 12/121,467

(22) Filed: May 15, 2008

(51) Int. Cl. H04B 1/38

(52) U.S. Cl. 455/74.1

(57) ABSTRACT

Methods and apparatus are provided for communicating between a host and a peripheral. In one embodiment, a method comprises the steps: establishing, in a manner transparent to the host, a wireless data link between a wireless hub device and a wireless peripheral device coupled to the peripheral, the wireless hub device coupled to and configured to communicate with the host, wherein the host is configured to communicate with peripheral devices over a wireline link at a plurality of data rates when connected via the wireline link; and controlling a flow of data between the host and the wireless hub device so that the host is unaware of the wireless data link, wherein the data is to be communicated between the host and the peripheral.

### BACKGROUND OF THE INVENTION

1. Field of the Invention

The present invention relates generally to wireless devices and more specifically to connectivity of wireless devices.

2. Discussion of the Related Art

Consumer devices that wirelessly connect with other devices have been a growing trend in the recent past. Wireless connectivity makes many consumer devices portable and reduces the wire clutter typically associated with devices that communicate with peripherals such as personal computers. In many environments, wireless connectivity increases user productivity and provides for an enhanced user experience. The addition of wireless connectivity features to many consumer devices has broadened the consumer base for the consumer devices. The proliferation of wireless devices has also expanded the applications available to users of consumer devices.

There are many specific examples of the wireless connectivity trend. Some examples include the wireless keyboard and the wireless mouse. Other examples include cameras that wirelessly transfer photographs to mass storage devices and home media servers that wirelessly stream data to video and audio appliances.

To facilitate wireless connectivity, a variety of standards have been promulgated that promote wireless device interoperability. For example, Bluetooth for personal area networks, IEEE 802.11 for local area networks, WiMAX for microwave data links, WiMedia for wireless ultra wideband networking, and Zigbee for wireless low power mesh network standard.

The Universal Serial Bus (USB) is a popular and ubiquitous wired serial bus standard. The USB standard defines a socket interface for host devices and plug interface for peripheral devices that makes connecting peripheral devices to hosts simple and easy. The plug and socket interfaces are commonly used to connect peripherals such as mice, flash memory jump drives, printers, and personal music players to hosts such as a computer. The USB interface has many advantages like low power consumption and low cost.

The USB standard also defines protocols that allow a host to automatically detect and configure a peripheral device. The USB standard is not a static standard but an evolving standard that is periodically updated. The USB standard is defined by a series of specifications, with each successive specification providing backward compatibility to legacy USB compliant hardware and software. For example, the USB 1.1 and the USB 2.0 standard, hereby incorporated by reference, are popular USB standards.

The USB 2.0 specification supports three primary data rates for peripheral devices: the Low Speed (LS) data rate at 1.5 Mega bits per second (Mbps); the Full Speed (FS) data rate at 12 Mbps; and the High Speed (HS) data rate at 480 Mbps. The LS data rate is normally used for communicating with low data rate peripherals such as a keyboard, a mouse or a stylus. FS data rates are normally used for communicating with peripherals that require somewhat higher data rates such as peripherals that provide or receive Integrated Services Digital Network (ISDN) data or digital audio content. Many scanners and printers communicate at FS data rates. HS data rates are often needed for peripherals that require very fast data rates, for example, peripherals that do image processing, mass data storage or mass data transfer.

The USB standard provides protocols for configuring USB enabled devices in a tiered star network topology. Each star in the network features a USB hub usually embedded in a host device. Each USB hub has a wired connection to the host and to one or more peripheral devices. Each host has a host controller that controls access to the peripheral devices wired to the hub. The host controller manages the peripheral devices by reporting the states of the devices, converting data communication protocols, generating data frames, and processing and handling data errors.

The USB standard provides for network topologies that comprise up to 127 peripheral devices connected to a host and up to five tiers of USB hubs. Hubs are either FS hubs or HS hubs. FS hubs support peripherals having data rates up to and including FS data rates and HS hubs support peripherals having data rates up to and including HS data rates.

HS hubs have a Transaction Translator (TT) that segregates FS and LS data from HS data by allocating hub bandwidth to HS data and hub bandwidth to FS and LS traffic. Hub bandwidth is usually provided to FS and LS data on a first come first serve basis.

The USB 2.0 specification also defines four types of data transfers namely bulk, isochronous, interrupt and control transfers. Isochronous and interrupt transfers are scheduled on a periodic basis and bulk and control transfers on a non-periodic basis. According to the USB 2.0 specification, the round trip response time delay between a USB device and the host computer may not exceed 18 bit times for LS and FS and for HS devices the round trip response must be between 736 and 816 HS bit times.

To provide the benefits of wireless connectivity to USB devices, the USB Implementers Forum has promulgated a Wireless USB (WUSB) specification as a wireless extension to the USB standard. WUSB features the Ultra-WideBand (UWB) wireless technology defined by the WiMedia Alliance. The WUSB specification provides for data rates of 480 Mbps and 110 Mbps with WUSB compliant devices with the devices operating in the 3.1-10.6 GHz range using a multi-band OFDM modulation scheme.

Notably, the WUSB specification does not support the use of hubs as the USB standard does. Also, the WUSB specification defines a new device class called a wire adaptor that is not backwardly compatible with legacy bus interfaces and bus software such as those that conform to USB 2.0. Additionally, software drivers need to be installed in the host to support WUSB making transition from wired USB to WUSB anything but transparent to the user.

Those skilled in the art will recognize that there is a need for wireless connectivity between consumer devices that feature traditional wired bus interfaces such as those that conform to the USB 2.0 standard.

### SUMMARY OF THE INVENTION

Several embodiments of the invention provide methods and devices for wireless communications. In one embodiment, the invention can be characterized as a method of communicating between a host and a peripheral, and a means for accomplishing the method, the method comprising the steps: establishing, in a manner transparent to the host, a wireless data link between a wireless hub device and a wireless peripheral device coupled to the peripheral, the wireless hub device coupled to and configured to communicate with the host, wherein the host is configured to communicate with peripheral devices over a wireline link at a plurality of data rates when connected via the wireline link; and controlling a flow of data between the host and the wireless hub device so that the host is unaware of the wireless data link, wherein the data is to be communicated between the host and the peripheral.

In another embodiment, the invention can be characterized as a communication system comprising a wireless hub device adapted to be coupled to a host and configured to communicate with the host, wherein the host is configured to communicate with peripheral devices over a wireline link at a plurality of data rates when connected via the wireline link. The system also comprises a wireless peripheral device adapted to be coupled to a peripheral. The wireless hub device is adapted to: establish, in a manner transparent to the host, a wireless data link between the wireless hub device and the wireless peripheral device; and control a flow of data between the host and the wireless hub device so that the host is unaware of the wireless data link, wherein the data is to be communicated between the host and the peripheral.

In yet another embodiment, the invention can be characterized as a method of communicating between a host and a peripheral comprising the steps: establishing, in a manner transparent to the host and the peripheral, a wireless data link between a wireless hub device and a wireless peripheral device coupled to the peripheral, the wireless hub device coupled to and configured to communicate with the host, the wireless peripheral device coupled to and configured to communicate with the peripheral, wherein the host and the peripheral are configured to communicate with each other over a wireline link at a plurality of data rates when connected via the wireline link; and controlling a flow of data between the host and the peripheral so that the host and the peripheral are unaware of the wireless data link, wherein the data is to be communicated between the host and the peripheral.

### BRIEF DESCRIPTION OF THE DRAWINGS

The above and other aspects, features and advantages of several embodiments of the present invention will be more apparent from the following more particular description thereof, presented in conjunction with the following drawings.

FIG. 1 shows a block diagram of an exemplary wired standard USB configuration.

FIG. 2 shows a block diagram of a wireless USB configuration according to an embodiment of the invention.

FIG. 3 shows a block diagram of a data path according to an embodiment of the invention.

FIG. 4 shows a block diagram of a hub according to an embodiment of the invention.

FIG. 5 shows a schematic diagram of a device according to an embodiment of the invention.

FIG. 6 shows a buffer management module according to an embodiment of the invention.

FIG. 7 shows an exemplary data structure for state data stored in a state register.

FIG. 8 shows a buffer according to an embodiment of the invention.

FIG. 9 shows the contents of a transaction buffer according to an embodiment of the invention.

FIG. 10 shows a polling sequence diagram 1000 according to an embodiment of the invention.

FIG. 11 shows a protocol engine 1100 according to an embodiment of the invention.

FIG. 12 illustrates the steps performed in communicating between a host and a peripheral according to an embodiment of the invention.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

The following description is not to be taken in a limiting sense, but is made merely for the purpose of describing the general principles of exemplary embodiments. The scope of the invention should be determined with reference to the claims.

Reference throughout this specification to “one embodiment”, “an embodiment”, or similar language means that a particular feature, structure, or characteristic described in connection with the embodiment is included in at least one embodiment of the present invention. Thus, appearances of the phrases “in one embodiment”, “in an embodiment” and similar language throughout this specification may, but do not necessarily, all refer to the same embodiment.

Some embodiments of the invention provide for the decoupling of a wireline protocol with a wireless protocol. For example, a wireless data link exists between two or more devices using a wireless protocol where the two or more devices are normally configured to communicate via a wireline link according to a wireline protocol. By way of example, the one or more devices include a host configured to communicate with one or more peripheral devices, for example, using a version of the USB standard. In some embodiments, the wireless communicating devices interface with one or more of the wireline devices and implement the wireless data link and wireless protocol in a manner transparent to the one or more wireline devices. For example, in some embodiments, one or more of the wireline device are unaware of the existence of a wireless data link therebetween and they behave as though the link therebetween were wired. In some embodiments, in order to decouple the wireline protocol from the wireless protocol, one or more of the interfacing devices that interface with the wireline devices control the flow of data between itself and the particular device so that the particular device is unaware of the wireless data link. For example, a wireless hub device interfaces with a wired host (e.g., a USB host controller) and controls the flow of data between the wireless hub device and the wired host so that the host in unaware of the wireless data link. This control of the flow of data may be done to ensure that the host maintains the communication link, to accommodate a wireless data rate that is different than (e.g., slower than) the expected wired data rate, and/or for error handling purposes, for example. In some embodiments, the wireless hub device will transmit signaling to the host to ensure that the communication link is maintained by the host and to maintain the transparency of the wireless protocol from the perspective of the wired host. For example, this signaling may include a negative acknowledgment (NAK), a packet error message, and/or a cyclic redundancy checking message. In embodiments in which the wired protocol is the USB 2.0 standard, the host expects all data and/or replies or responses from the peripheral devices within an allotted time period, for example, within 16 bit-times. In the event the wireless data link can not deliver the data, reply and/or response within the allotted time period, the wireless hub device will transmit signaling to the host so that the host maintains the communication link. In some embodiments, the sending of signals to the host device for one or more of the purposes described above may be referred to as spoofing the host.

In some embodiments, this decoupling of the wireless and wired protocols allows for a variety of effective wireless data communication rates including effective data rates that are not specifically provided for wire-line standards such as USB 2.0 and wireless standards such as WUSB. Thus, some embodiments provide for effective data rates between a host and a peripheral that are different than the data rates supported by the host. For example, in the context of USB communications supporting a High Speed (HS) data rate of 480 Mbps, a Full Speed (FS) data rate of 12 Mbps and a Low Speed (LS) data rate of 1.5 Mbps, effective data rates between a USB host and peripheral are provided that are the same as or different than these defined rates. In one further example, an effective rate of communication between the HS data rate and the FS data rate is provided and may be referred to as a full speed plus (FS+) data rate. These non-standard data rates facilitate the establishment of wireless data links that generally have varying effective data rates that depend on many factors, such as the transmission path length of the data link and the underlying environmental conditions surrounding the data link.

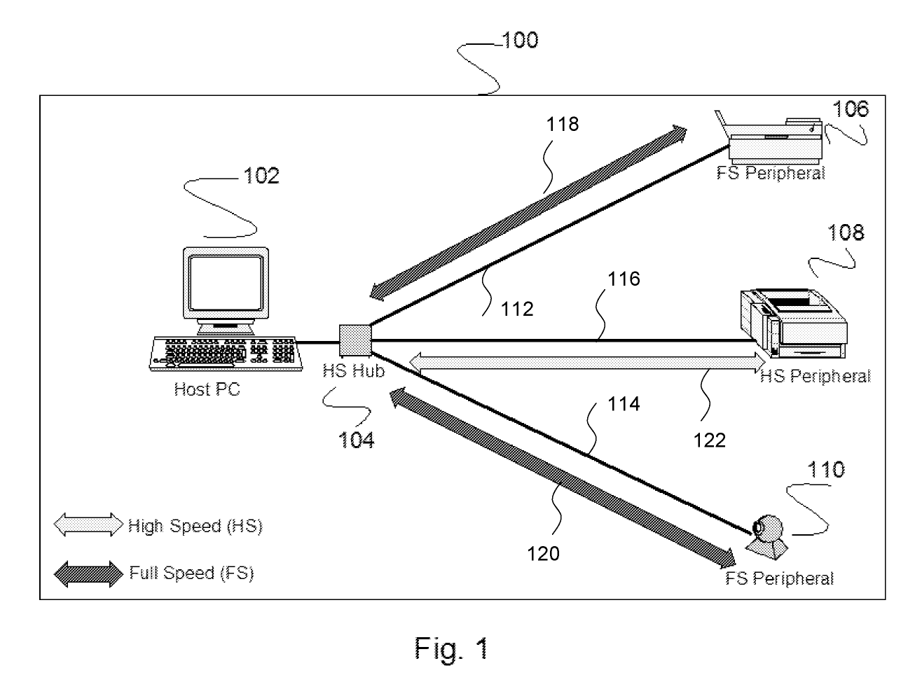

Referring first to FIG. 1, a block diagram of an exemplary conventional USB configuration 100 is shown. The USB configuration 100 includes a host PC 102 having a HS hub 104 connected to two Full Speed (FS) peripheral 106, 110 through cables 112, 114. The HS hub 104 is also connected to a HS peripheral 108 through cable 116. It is understood that the host PC 102 includes a USB host controller (which may be generically referred to as a host controller) that controls communications with one or more peripherals (including the HS hub 104) according to the USB standard.

Cables 112, 114 provide wireline data conduits for full speed data streams 118, 120. Cable 116 provides a data conduit for a HS data stream 122.

The HS hub 104 has sockets (not shown) that receive plugs (not shown) located at the ends of cables 112, 114, 116. The plugs mate with the sockets allowing easy attachment and detachment of peripheral devices, such as peripheral 106, 108, 110.

The HS hub 104 detects the speed of each peripheral device connected to the HS hub 104, such as peripherals 106, 108, 110 and adjusts to communicate with each peripheral device at the appropriate speeds. In this embodiment, the HS hub 104 thus forms a USB branch that supports high speed, full speed and low speed devices. In other embodiments, the HS hub 104 and peripherals form a branch of a larger USB tree structure.

On receiving HS data packets, the HS hub 104 decodes the HS data packets. HS data packets addressed to the HS peripheral 108 are forwarded to the HS peripheral 108 in the HS data stream 122 through cable 116. HS data packets addressed to the FS peripherals 106, 110 are translated by the HS hub 104 into FS data packets and forwarded to the FS peripherals 106, 110 in respective FS data streams 118, 120 through cables 112, 114.

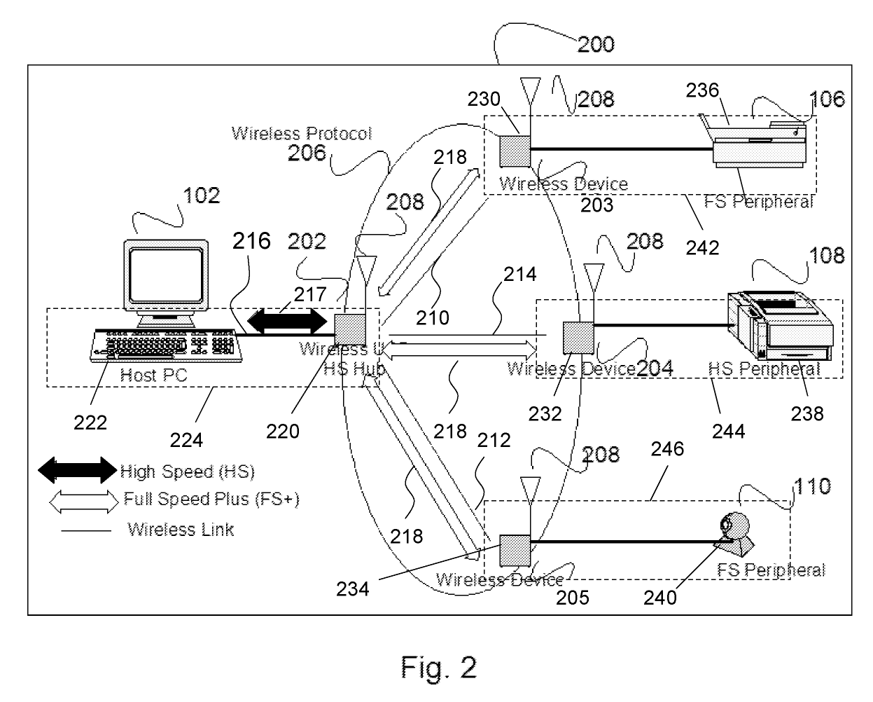

Referring next to FIG. 2, a block diagram of an exemplary wireless USB configuration 200 is shown in accordance with several embodiments of the invention. The USB configuration 200 includes a host PC 102 (which may be generically referred to as a host which generally includes a host controller) connected with a wireless hub 202 (which may also be referred to as a wireless hub device). The wireless hub 202 (e.g., a host-side wireless device or transceiver) is in communication with wireless peripheral devices 203, 204, 205 (e.g., peripheral-side wireless devices or transceivers) through wireless data links 210, 212, 214. That is, the wireless data link is established between the wireless hub 202 and each of the wireless peripheral devices 203, 204, 205. The wireless hub 202 and the wireless peripheral devices 203, 204, 205 each have antennas 208 defining respective ends of the wireless data links 210, 212, 214. The wireless peripheral devices 203, 205 are connected to the FS peripherals 106, 110. The wireless peripheral device 204 is connected to the HS peripheral 108.

The wireless hub 202 decodes HS data packets received from the host PC 102 through a HS 216 wired connection. HS data packets addressed to the HS peripheral 108 are forwarded to the HS peripheral 108 through wireless data link 214 and wireless device 204 according to a wireless protocol. HS data packets addressed to the FS peripherals 106, 110 are translated by the wireless hub 202 and forwarded to the FS peripherals 106, 110 through wireless data links 210, 212 and respective wireless peripheral devices 203, 205.

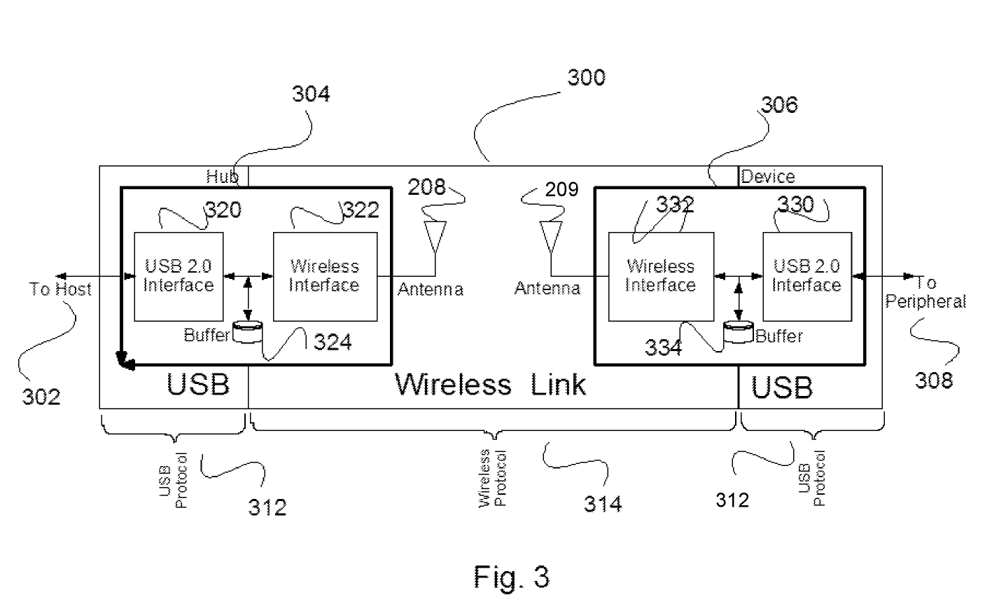

Wireless connectivity between the host PC 102 and each of the peripheral devices 106, 108, 110 is achieved through the wireless hub 202 and wireless peripheral devices 203, 204, 205 using the wireless data links 210, 212, 214 according to a wireless protocol 206. Accordingly, in some embodiments the wireline protocol is decoupled from a wireless protocol (as is also illustrated in FIG. 3). In some embodiments, the wireless data links 210, 212, 214 are established in a manner in a manner transparent to the one or more of the host PC 102 and the peripherals 106, 108, 110. For example, in some embodiments, from the perspective of the host PC 102, the host PC 102 behaves as though it were connected via a wireline connection direct to the peripherals 106, 108, 110 and is unaware of the wireless data links established by the wireless hub 202. Similarly, in some embodiments, one or more of the peripherals 106, 108, 110 are unaware of the existence of the established wireless data links and they behave as though they were connected to the host PC 102 by wireline. In order that the wireless data links appear transparent to the host PC 102 and one of more of the peripherals 106, 108, 110, the wireless hub 202 and the wireless peripheral devices 203, 204, 205 include a wireline interface that allows connection with the host PC 102 and the peripherals 106, 108, 110, respectively. In several embodiments, the wireline interfaces are USB interfaces. The wireline interfaces are configured to allow communication according to the USB protocol with the host PC 102 and the peripherals 106, 108, 110, respectively. Furthermore, in some embodiments, the wireless hub 202 controls the flow of data between itself and the host PC 102 so that the host PC is unaware of the wireless data link, i.e., the wireless hub 202 emulates a USB peripheral from the perspective of the host PC 102. This control of the flow of data is done to ensure that the host PC 102 maintains the communication link, for example in order to accommodate a wireless data link having a data rate different than (e.g., slower than) the expected wired data rate had the host PC 102 been directly connected to a peripheral by a wireline connection. Additionally, the flow of data is controlled so that the host PC will maintain the link to account for error handling and re-transmissions that may be needed with the wireless data links. In some embodiments, one or more of the peripheral wireless devices 203, 204, 205 controls the flow of data between itself and the respective peripheral 106, 108, 110 so that the particular peripheral is unaware of the wireless data link, i.e., the wireless peripheral device 203, 204, 205 emulates a USB host from the perspective of the peripheral.

In some embodiments, the wireless hub 202 transmits signaling to the host PC 102 to ensure that the communication link is maintained by the host PC 102 and to maintain the transparency of the wireless protocol from the perspective of the host PC. For example, this signaling may include a negative acknowledgment (NAK), a packet error message, and/or a cyclic redundancy checking message. In embodiments in which the wired protocol is the USB 2.0 standard, the host PC 102 expects all data and/or replies or responses from the peripherals 106, 108, 110 within an allotted time period, for example, within 16 bit-times. In the event a given wireless data link can not deliver the data, reply and/or response within the allotted time period, the wireless hub 202 transmits signaling to the host PC 102 so that the host PC maintains the communication link. In the USB protocol, when the host PC receives the NAK or other signal, the host PC 102 will not tear down the communication link and will send an additional request for the data, reply or response, which provides an additional period of time for the wireless hub 202 to obtain and deliver the information to the host PC 102. In some embodiments, the sending of signals to the host PC for one or more of the purposes described above may be referred as to spoofing the host PC.

In accordance with some embodiments, the decoupling of the wireless and wired protocols allows for a variety of effective wireless data communication rates over the wireless data links 210, 212, 214 including effective data rates that are not specifically provided for wire-line standards such as USB 2.0 and wireless standards such as WUSB. Thus, some embodiments provide for effective data rates between the host PC 102 and the peripherals 106, 108, 110 that are different than the data rates supported by the host PC and the peripherals 106, 108, 110. For example, in the context of USB communications supporting a High Speed (HS) data rate of 480 Mbps, a Full Speed (FS) data rate of 12 Mbps and a Low Speed (LS) data rate of 1.5 Mbps, effective data rates between the host PC 102 and peripherals 106, 108, 110 are provided that are the same as or different than these defined rates. In the illustrated embodiment of FIG. 2, a rate of communication between the HS data rate and the FS data rate is provided, referred to herein as a full speed plus (FS+) data rate. These non-standard data rates facilitate the establishment of wireless data links that generally have varying effective data rates that depend on many factors, such as the transmission path length of the data link and the underlying environmental conditions surrounding the data link.

To achieve the wireless FS+ data rates or other non standard data rates, in several embodiments, the wireless hub 202 communicates with the host PC 102 using a standard data rate that is compliant with the host PC protocol such as the USB 2.0 compliant HS 217 data rate as shown in FIG. 2. The wireless hub 202 buffers data and transmits the data to wireless peripheral devices 203, 204, 205 over wireless data links 210, 212, 214 at a FS Plus (FS+) data rate or other data rate not supported by the host PC 102. The wireless data rate can be any data rate up to the data rate supported by each of the wireless data links 210, 212, 214. Since the FS+ data rate is slower than the HS data rate expected by the host PC 102 and to reduce the effective data rate between the host PC 102 and the wireless hub 202, the wireless hub 202 controls the flow of data to the host PC 102 as needed and as described herein.

In several embodiments, the wireless peripheral devices 203, 204, 205 communicate with peripherals 106, 108, 110 at the specific discrete data rates supported by each of the peripherals 106, 108, 110 which in one embodiment, are the rates supported by the USB standard. The wireless peripheral devices 203, 204, 205 control the flow of data to the respective peripherals 106, 108, 110 as needed. For example, the wireless peripheral devices 203, 204, 205 buffer data and transmit signaling so that the peripherals 106, 108, 110 as needed maintain the communication link with the wireless peripheral devices. As described above, the transmitted signaling may include transmitting a NAK, a packet error message, and/or a cyclic redundancy checking message. In other words, the wireless peripheral devices 203, 204, 205 spoof the respective peripherals 106, 108, 110 as needed. The wireless peripheral devices 203, 204, 205 also transmit data to the wireless hub 202 over the wireless data links 210, 212, 214 at the FS+ data or other data rate not supported by the host PC 102. The wireless data rate can be any data rate up to the data rate supported by each of the wireless data links 210, 212, 214.

The precise data rate supported by each of the wireless data links 210, 212, 214 may vary between wireless data links and over time. The variance may occur because the data rate is dependent on many exogenous factors such as the distance between the wireless hub 202 and each of the wireless peripheral devices 210, 212, 214 and the underlying environmental conditions of the wireless data link.

It can be appreciated that the bandwidth and effective data rates of a wireless data link will generally vary significantly from those of a wired data link. It can also be appreciated that by operating each wireless data link 210, 212, 214 at an adaptable rate or other non-standard data rate, the wireless USB configuration 200 provides a considerable communication throughput advantage over a system that merely falls back to the FS data rate when wireless conditions do not allow for a HS data link as is the case in conventional wired USB systems.

Advantages of embodiments that provide a data rate in between two standard rates of the wired protocol, such as an FS+ data rate, may be more fully appreciated through a more specific example. If the host PC 102 has HS data traffic bound for HS peripheral 108 and wireless data link 214 does not have adequate bandwidth to support the HS data, the data may be sent from the host PC 102 to the HS peripheral at an intermediate FS+ effective data rate, i.e., a data rate in between HS and FS, instead of falling back to the next lowest supported data rate, FS. The wireless hub 202 communicates with the host PC 102 according to the HS protocol, buffering data and controlling data flow between itself and the host PC 102 by transmitting signaling as needed to the host PC 102, such as negative acknowledgments (NAKs), packet ID errors, CRC errors or the like. In the illustration of FIG. 2, the wireless peripheral device 204 is configured to communicate with the HS peripheral 108 at a HS data rate and controls the flow of data between itself and the peripheral 108 so that the data flow from the wireless peripheral device 204 sends data to the peripheral 108 at an FS+ effective data rate and the HS peripheral 108 maintains the link. Additionally, it is noted that as illustrated in FIG. 2, wireless peripheral devices 203 and 205 communicate with peripherals 106 and 110 at FS, where the wireless data rate is FS+. In this case, the flow of data is controlled by the wireless peripheral devices 203 and 205 as needed to match the data rate expected by the peripheral. Notably the FS+ data rate is not ostensibly supported by either the host PC 102 or the peripheral device 108. That is, the FS+ effective data rate is higher than the FS data rate and lower than the HS data rate that are ostensibly supported by the host PC 102 and the peripheral 108. This provides a considerable throughput advantage over a wireless system that supports only standard data rates and falls back to the next lower standard data rate (such as Full Speed) when adequate bandwidth is unavailable.

Those skilled in the art will also recognize that in some embodiments, the wireless hub 202 and the wireless peripheral devices 203, 204, 205 communicating using wireless protocol 206 as shown in FIG. 2 provide a functional substitute for the wired HS hub 104 of FIG. 1. The embodiments of FIG. 2 eliminate the need for routing wires from the host PC 102 to each of the peripherals 106, 108, 110. Additionally, no additional software or other drivers are needed to be installed at the host PC 102 in order for the host PC 102 to communicate with the peripherals via the wireless data links.

It can also be appreciated that the wireless hub 202 may be embedded in the host PC 102 or embodied as a separate unit as shown in FIG. 2. That is, in one embodiment, the wireless hub 202 is implemented within one housing 220 that is separate and distinct from a host housing 222 with appropriate interfacing connectors therebetween. Alternatively, the wireless hub 202 is implemented and integrated with the host PC 102 within a housing (illustrated as dashed housing 224). Similarly, the wireless peripheral devices 203, 204, 205 may be embedded in respective peripherals 106, 108, 110 or embodied as separate units. That is, in one embodiment, one or more of the wireless peripheral devices 203, 204, 205 are implemented within housings 230, 232, 234 that are separate and distinct from peripheral housings 236, 238, 240 with appropriate interfacing connectors therebetween. Alternatively, one or more of the wireless peripheral devices 203, 204, 205 are implemented and integrated with the peripherals 106, 108, 110 within a housing (illustrated as dashed housings 242, 244, 246). For example, in the case of USB devices, the wireless hub 202 may connect to a USB port of the host PC 102, and/or one or more of the wireless peripheral devices 203, 204, 205 may connect to the USB port of the peripherals 106, 108, 110.

The embodiment shown in FIG. 2 is exemplary. The number of peripherals and respective wireless data links shown is exemplary. The data rates of the peripherals FS and HS as well as the illustrated FS+ effective data rate are also exemplary. Those skilled in the art will recognize that other embodiments feature LS peripherals and peripherals having speeds other than FS, HS, or LS. Although the illustrated embodiment features the wireless hub 202 and peripheral wireless devices 203, 204, 205 that communicate with the host PC 102 and the peripherals 106, 108, 110 at USB compliant data rates, embodiments featuring a host, a wireless hub, wireless peripheral device/s and peripherals compliant with other protocols, standards and specifications are contemplated.

Referring next to FIG. 3 a block diagram of a data path 300 according to an embodiment of the present invention is shown. The data path 300 includes a wireless hub 304 (one embodiment of the wireless hub 202) in communication with a wireless peripheral device 306 (one embodiment of wireless peripheral devices 203, 204, 205) using a wireless protocol 314.

The wireless hub 304 has a host USB interface 320 (which may be generically referred to as a host interface), a buffer 324 and a host-side wireless interface 322. The buffer 324 is connected with the host USB interface 320 and the host-side wireless interface 322. The host USB interface 320 connects the wireless hub 304 with a host 302 (e.g., host PC 102). The wireless interface 322 is coupled to an antenna 208.

The wireless peripheral device 306 has a peripheral-side wireless interface 332, a buffer 334 and a peripheral USB interface 330 (which may be generically referred to as a peripheral interface). The buffer 334 is connected with the peripheral-side wireless interface 332 and the peripheral USB interface 330. The peripheral USB interface 330 connects the wireless peripheral device 306 with a peripheral 308 (e.g., one of peripherals 106, 108, 110). The peripheral-side wireless interface 332 is coupled to an antenna 209.

FIG. 3 illustrates the decoupling of a wireline protocol (e.g., the USB protocol 312) from the wireless protocol 314. The USB protocol 312 is used by the wireless hub 304 and wireless peripheral device 306 to communicate with the host 302 and the peripheral 308, respectively. However, the wireless protocol 314 is used for communications between the wireless hub 304 (one embodiment of the wireless hub 202 described herein) and the wireless peripheral device 306 (one embodiment of the wireless peripheral devices 203, 204, 205 described herein). Those skilled in the art will appreciate that the host USB interface 320 allows the wireless hub 304 to communicate with the host 302 according to the USB protocol 312. Similarly, the peripheral USB interface 330 allows the wireless peripheral device 304 to communicate with the peripheral 308 according to the USB protocol 312. This provides the host 302 and the peripheral 308 with a virtual wired USB environment even though the wireless protocol 314 is used for communications between the wireless hub 304 and the peripheral wireless device 306.

This decoupling allows the host-side wireless interface 322 and peripheral-side wireless interface 332 to establish a wireless data link therebetween using the wireless protocol 314 that is largely independent of the USB protocol 312. The wireless data link can thus have an effective data rate that is the same as or different than the data rates supported by the USB protocol. For example, as illustrated in the embodiment of FIG. 2, the wireless protocol 314 can support a data rate in between supported rates of the USB protocol 312, such as a FS+. In other examples, the wireless protocol 314 may support a rate that is the same as, less than or greater than the rates supported by the USB protocol 312. The effective data rate of the wireless data link supported by the wireless protocol may also vary over time allowing the data link to adapt to environmental changes and other changes that effect data link capacity.

It can also be appreciated that the wireless hub 304 can be conveniently embedded in the host 302 and that the wireless peripheral device 306 may be embedded in the peripheral 308 or that the wireless hub 304 and the wireless peripheral device 306 may be embodied as independent units with wired connections to the host 302 and the peripheral 308. Other embodiments have wireless hubs 304 and wireless peripheral devices 306 that conform to other bus standards, conventions, or ad hoc agreements. It is understood that the wireless hub 304 and wireless peripheral devices 306 of these embodiments include the appropriate compliant interfaces to interface with the particular host and peripherals according to the particular standards, conventions or ad hoc agreements. It can also be appreciated that the wireless protocol 314 can be implemented with a static or adaptable data rate.

In several embodiments, host-side wireless interface 322 and the peripheral-side wireless interface 332 include wireless transmit and receive circuitry, or transceiver circuitry to communicate signaling conveying data. In one embodiment, the interfaces 322 and 332 comprise radio frequency transceivers capable of transmitting and receiving, and encoding and decoding signaling having at wide band frequency bands. For example, in one embodiment, the interfaces 322 and 332 communicate wideband signaling having bandwidth that is at least 2% or at least 10% of the center frequency of the signaling. In other embodiments, the interfaces 322 and 332 communicate ultra-wideband (UWB) signaling having bandwidth that is at least 20% of the center frequency of the signaling. Such UWB transceivers have large inherent bandwidths providing for very high data rates at short distances. UWB components are generally power efficient, cost effective, robust and easy to manufacture and package as an ASIC. In several embodiments, other high speed wireless links such as those compliant with IEEE 802.11 g/n are featured. Wideband band and UWB transceivers that may be implemented in several embodiments of the invention are described more thoroughly in U.S. Pat. Nos. 6,895,059 and 7,321,601, all of which are incorporated herein by reference.

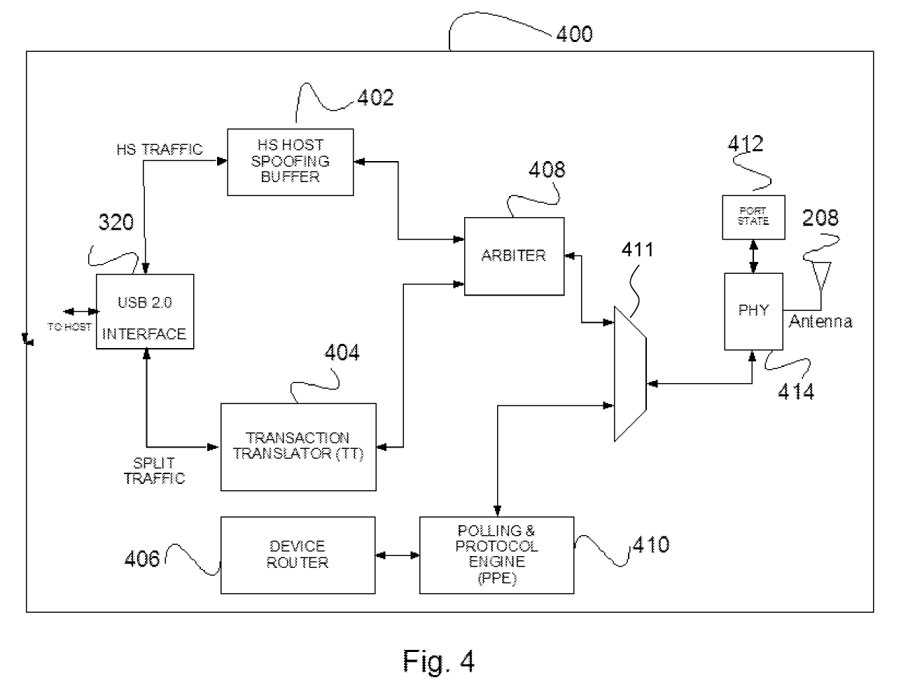

Referring next to FIG. 4 a functional block diagram of a wireless hub 400 according to an embodiment of the invention is shown. The wireless hub 400 includes the USB interface 320 that is connected with a spoofing buffer 402 (which may be generically referred to as a data flow control buffer) and a Transaction Translator (TT) 404. The spoofing buffer 402 and the TT 404 are connected with an arbiter 408. The wireless hub 400 also includes a device router 406 connected with a Polling and Protocol Engine (PPE) 410. The PPE 410 and the arbiter 408 are connected to the inputs of a multiplexer 411. The multiplexer 411 is connected with a physical layer module PHY 414. The PHY 414 is connected with a port state module 412 and the antenna 208. These components may be variously implemented in circuitry or a microprocessor and memory.

In one embodiment, the USB interface 320 provides the wireless hub 400 with a USB 2.0 compliant interface for communicating with a host. The USB interface 320 encodes and decodes USB data traffic according to the USB specification. In one embodiment, high speed data traffic is routed to the spoofing buffer 402 with FS and LS traffic routed to the TT 404.

The spoofing buffer 402 and the TT 404 are in communication with the arbiter 408. The arbiter 408 arbitrates conflicts between the spoofing buffer 402 data traffic and TT 404 data traffic. High speed traffic from the spoofing buffer 402 is generally given priority over slower speed split traffic from the TT 404. In this way, the arbiter 408 ensures that significant bandwidth for the HS traffic is made available on the wireless link. The arbiter 408 also routes HS traffic received by the PHY 414 to the spoofing buffer 402 and routes other traffic from the PHY 414 to the TT 404.

In several embodiments, the spoofing buffer 402 buffers data addressed to a high speed peripheral in order to control the flow of data. Buffering may be needed since the wireless data link between the wireless hub 400 and a wireless peripheral device (not shown) may not have adequate bandwidth to support high speed data traffic. In this case, the spoofing buffer would control the flow of data to the host PC. For example, the flow of data is controlled by transmitting signaling to the host PC, such as negative acknowledgments (NAKs), packet ID errors, CRC errors or the like to the host so that the host PC will maintain the communication link. Thus, the spoofing buffer 402 spoofs the host into communicating at a lower effective data rate while maintaining the communication link. These communications back to the host cause the host PC to re-request the data desired without timing out and taking down the connection. The spoofing buffer 402 also buffers data and transmits the data at a rate supported by the data link. In many instances, this data rate would be an FS+ data rate (i.e. between a FS and HS data rate).

The TT 404 decodes HS data packets and detects split tokens embedded in the packets that indicate split transactions. The TT 404 checks the hub address field of each split token to determine if it is being targeted by the split transaction. If so, the TT 406 has transaction buffers 420 that accept the split transactions and translate the HS data packets to FS and/or LS data packets.

The TT 404 is invoked when a FS or LS device (not shown) joins the wireless network. In a preferred embodiment, there is only one TT 404 because of the inherent bandwidth limitations of wireless data links. The TT 404 buffers full speed and low speed data between the host PC and the peripheral.

The PPE 410 generates messages such as polling messages for the wireless peripheral devices in range. The messages are sent to the wireless peripheral devices according to the wireless protocol. The polling messages are used to ascertain the presence of and the speeds of the wireless peripheral devices and command events such as reset, suspend, resume and wake up. Thus, the PPE 410 provides the messages needed to make the wireless hub to device wireless connection a seamless connection. The PPE 410 also performs many of the functions of a port state machine in a wired USB port.

A Device Router (DR) 406 tracks device addresses obtained by the PPE 410 through polling operations. The device addresses are use by the PHY 414 to establish wireless links with appropriate devices.

Messages from the PPE 410 and the arbiter 411 are multiplexed and de-multiplexed in the multiplexer 411. The multiplexer is connected to the PHY 414 where messages are transmitted and received over antenna 208. In one embodiment, an ultra-wideband data link is preferred due to the large inherent bandwidth of UWB links providing link capacity to transmit data at or near high speed data rates.

The port state module 412 tracks the port connections and wireless links. The port state module tracks changes to the states of devices in communication with the hub 400. Changes to the state of the devices may be reported to the host PC.

One skilled in the art will recognize that the wireless hub 400 appears to a host as a USB hub and the design of the host to hub interface is unaffected by wireless hub 400. That is, wireless hub 400 will operate with a host that is USB compliant. It is understood that while the host is often referred to as a host PC throughout this specification, that the host device may or may not be implemented as a personal computer. For example, the host may be implemented as any general or specific purpose computing device including a host controller that controls communications over a wireline data link according to a wireline standard.

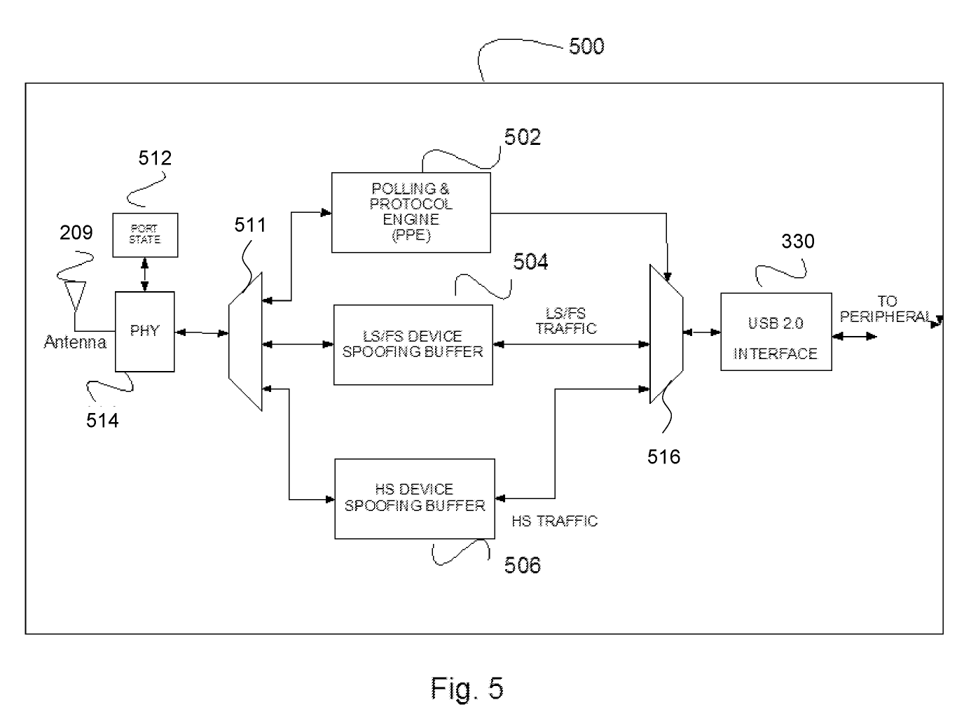

Referring next to FIG. 5, a wireless peripheral device 500 (e.g., a peripheral-side wireless device) according to an embodiment of the invention is shown. An antenna 209 is connected with a physical layer module (PHY) 514. The PHY 514 is connected with a port state module 512 and multiplexer 511. Multiplexer 511 is connected with a polling and protocol engine (PPE) 502, a low speed/full speed device (LS/FS) spoofing buffer 504, and a HS spoofing buffer 506. It is noted that the buffers 504 and 506 may be generically referred to as data flow control buffers. The PPE 502 and the spoofing buffers 504, 506 are connected to multiplexer 516. Multiplexer 516, in turn, is connected with USB interface 330. USB interface 330 is connected to a peripheral, e.g. one of peripherals 106, 108, 110.

In some embodiments, the antenna 209 and PHY 514 are operative to generate a wireless data link between the wireless peripheral device 500 and a wireless hub (not shown). The port state module 512 tracks the USB bus state of the USB peripheral. The USB bus state can be passed to the wireless hub when a polling message is received. The port state module 512 also tracks changes to the state of the hub (not shown) that is in communication with the wireless peripheral device 500. Changes to the state of the wireless hub may be reported to the peripheral.

Messages received from the wireless hub and bound for the wireless hub are de-multiplexed and multiplexed in a multiplexer 511. The Polling and Protocol Engine (PPE) 502 responds to polling messages sent from the wireless hub and generates protocol messages.

The LS/FS spoofing buffer 504 stores LS and FS traffic received from the wireless hub. Data received through a split transaction from the wireless hub is decoded and stored and in the spoofing buffer 504. The LS/FS spoofing buffer 504 verifies the data received from the wireless hub is error free and if not requests that the data be resent. The LS/FS spoofing buffer 504 controls the flow of data between the wireless peripheral device 500 and the peripheral. For example, the LS/FS spoofing buffer 504 forwards the decoded data to the peripheral 308 through multiplexer 516 and the USB interface 330. The LS/FS spoofing buffer 504 also stores data bound for the wireless hub. In some embodiments when the effective wireless data rate is faster than the data rate of the peripheral, the flow of data to the peripheral is controlled as needed, e.g., buffered and/or delayed to match the expected timing of the peripheral.

The HS spoofing buffer 506 stores high speed data traffic received from the hub (not shown). The HS spoofing buffer 506 controls the flow of data to the peripheral as needed and causes the peripheral to re-request the data desired without timing out or taking down the connection. For example, as described above, when the effective wireless data rate is less than the data rate of the peripheral, the spoofing buffer 506 sends signaling, such as negative acknowledgments (NAKs), packet ID errors, CRC errors or the like, to the peripheral so that the peripheral will maintain the communication link. Thus, the spoofing buffer 402 spoofs the peripheral into communicating at a lower effective data rate. The HS spoofing buffer 506 forwards the data to the peripheral through the multiplexer 516 and the USB interface 330. Thus spoofing buffers 504, 506 provide data to the USB interface 330 so that the USB may communicate with the peripheral in conformance with the USB protocol.

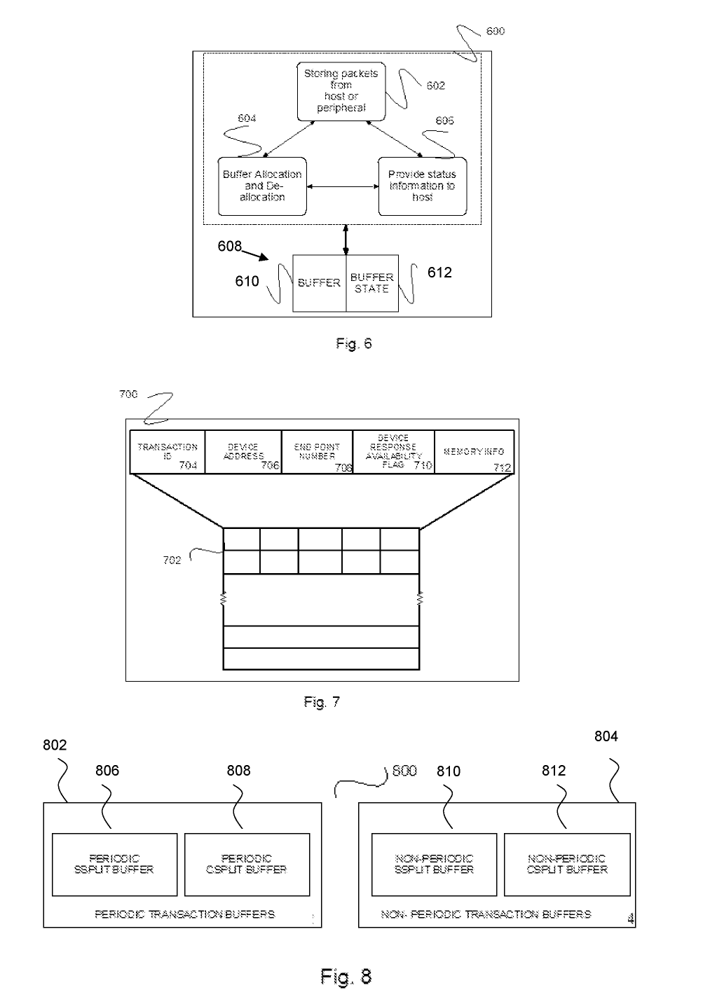

Referring next to FIG. 6 a buffer management module 600 according to an embodiment of the invention is shown. In several embodiments the buffer management module is part of the HS host spoofing buffer 402 shown in FIG. 4. The buffer management module 600 has a packet store routine 602, a buffer allocation routine 604 and a status routine 606. The buffer management module communicates with a plurality of buffers 608 that have one or more data registers 610 and one or more state registers 612.

The packet store routine 602 manages the one or more buffers 608 by storing data in the data registers 610 and state information in the state registers 612. The buffer allocation routine 604 allocates and de-allocates each of the plurality of buffers 608. The status routine 606 provides status information to the host or peripheral.

Referring next to FIG. 7 an exemplary data structure for state transaction information stored in a state register 700 is shown. The state information includes a Transaction ID 704, a device address 706, an end point number 708, a device response availability flag 710 and memory information 712.

The transaction ID 704 identifies the transaction stored in the transaction buffer. The device address 706 is a target address associated with the transaction stored in the buffer. The End Point Number 708 is the number of the device being addressed in the transaction. The Device Response Availability Flag 710 tracks whether the device being addressed is available. The memory storage information field 712 contains details of where the transaction data is stored in the buffers. For example, the memory storage information field 712 may contain the start or end addresses in the memory and the data size.

Referring next to FIG. 8 exemplary buffers according to an embodiment of the invention are shown. The transaction buffers include periodic transaction buffers 802 non-periodic transaction buffers 804. The periodic transaction buffers 802 are further broken down into buffers for periodic SSPLIT buffers 806 and CSPLIT buffers 808. Similarly, the non-periodic transaction buffers 804 are further broken down into buffers for non-periodic SSPLIT buffers 810 and CSPLIT 812 buffers.

The periodic buffers 802 and the non-periodic buffers 804 buffer data that is addressed to a HS peripheral. The buffers are used when the wireless data links cannot support HS data rates. These FS+ transactions are supported by controlling the flow of data with the host by transmitting Negative Acknowledgments (NAKs) messages, Packet ID (PID) errors, CRC errors or the like to the host PC, e.g., the host PC is spoofed. During spoofing, HS transactions are buffered at the wireless hub or the wireless peripheral device. An exemplary embodiment of spoofing can be found in the pseudo code presented and explained hereinafter.

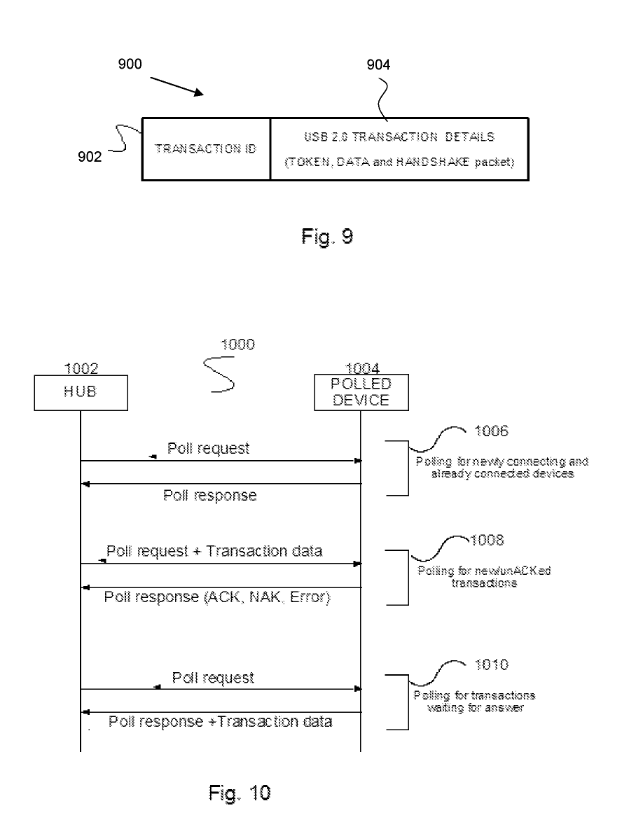

Referring next to FIG. 9 the contents of an exemplary transaction buffer 900 according to an embodiment of the invention is shown. The transaction buffer 900 contains a transaction ID 902 and transaction details 904. These transaction details 904 may include a token, data and handshake packets.

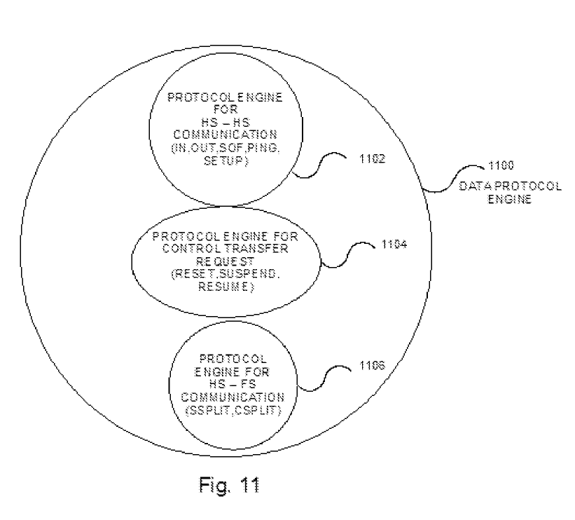

Referring next to FIG. 10 a polling sequence diagram 1000 according to an embodiment of the invention is shown. The polling engine polls devices 1004. The polling engine may for example poll in a sequence comprising (i) a first polling sequence 1006 that polls wireless peripheral devices that are newly connected and already connected devices; (ii) a second polling sequence 1008 that polls devices that have new or unacknowledged transactions and (iii) a third polling sequence 1010 that polls wireless peripheral devices for transactions awaiting a response.

The polling engine thus periodically polls devices facilitating smooth processing of transactions. In the case of the first message sequence 1006, the wireless hub sends a poll request message to the wireless peripheral device; the wireless peripheral device in turn sends a poll response. In the case of second message sequence 1008; the wireless hub sends the poll request along with the transaction data; the wireless peripheral device in turn responds with an ACK, NAK or an error message. In the case of the third message sequence 1010, the wireless hub sends a polling request to the wireless peripheral device; and the wireless peripheral device in turn sends a poll response with the transaction data.

Referring next to FIG. 11 a data protocol engine 1100 according to an embodiment of the invention is shown. In this embodiment, the protocol engine 1100 is part of the polling engine 1000. The protocol engine handles different USB tokens, transactions and control transfer requests. The protocol engine 1100 is comprised of three logical routines. The three logical routines include a HS host to HS peripheral routine 1102, a HS host to FS (or LS) peripheral routine 1106 and a control transfer request and response routine 1104:

The HS host to HS peripheral routine 1102 involves different USB tokens such as IN, OUT, PING, SETUP and Start of Frame (SOF). The HS host to FS peripheral routine 1106 involves split transactions (SSPLIT and CSPLIT). The control transfer request and response routine 1104 involves RESET, SUSPEND and RESUME transfer requests and corresponding responses.

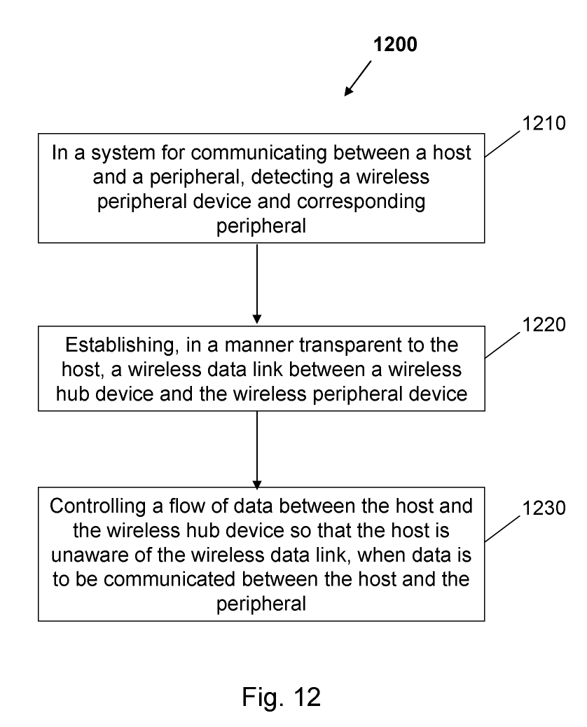

Referring next to FIG. 12, a method 1200 is shown for communicating between a host and a peripheral according to an embodiment of the invention, wherein the host is configured to communicate with peripheral devices over a wireline link when connected via a wireline link. The host may be any computer-type or microprocessor controlled device for example, and includes a host controller or other device that supports communication according to a standard such as the USB standard, for example.

In one embodiment, the method includes detecting a wireless peripheral device and a corresponding peripheral (STEP 1210). In some embodiments, the detecting step is performed by a wireless hub device, e.g., wireless hub 202 detects wireless peripheral/s 203, 204, 205 and corresponding peripherals 206, 208, 210. The wireless hub device is configured to communicate with the host and the wireless peripheral device is configured to communicate with the corresponding peripheral. Since the communication system involves wireless devices that are capable of moving or being moved, the detecting device (e.g., wireless hub device) continually polls for wireless peripheral devices that are within communication range. According to several embodiments where the host is adapted to communicate with peripheral devices over the wireline link at a plurality of data rates, the data rate/s supported by the peripheral are also detected. The peripheral in several embodiments is configured to communicate at a first data rate, the first data rate being one of a plurality of data rates supported by a host. For example, in the context of wireline USB, the plurality of data rates may include HS (480 Mbps), FS (12 Mbps) and LS (1.5 Mbps).

As is described herein, the wireless peripheral device and the peripheral may be integrated into a single device or may be separate devices coupled together. Also, like peripherals described herein, the peripheral may be for example a wireless mouse, keyboard, printer, scanner, audio player, camera, etc. The peripheral may have electronics that support communicating according to a standard such as the wireline USB standard, for example. As is described herein, the wireless hub device and the host (e.g., host PC 102) may be integrated into a single device or may be separate devices coupled together.

Next, a wireless data link is established between a wireless hub device and the wireless peripheral device in a manner that is transparent to the host (STEP 1220). For example, in some embodiments, from the perspective of the host, the host behaves as though it were connected via a wireline connection direct to the peripheral and is unaware of the wireless data link established between the wireless hub device and the wireless peripheral device. Accordingly, the host does not tear down the communication link when the wireless data link is established. In some embodiments, as described herein, the wireless hub device includes a wireline interface to interface with the host, e.g., a USB interface in the event the host communicates using a version of the USB standard. In some embodiments, the wireless data link is established in a manner that is also transparent to the peripheral. For example, in this embodiment, from the perspective of the peripheral, the peripheral behaves as though it were connected via a wireline connection direct to the host (or hub of the host) and is unaware of the wireless data link established between the wireless hub device and the wireless peripheral device. In some embodiments, as described herein, the wireless peripheral device includes a wireline interface to interface with the peripheral, e.g., a USB interface in the event the peripheral communicates using a version of the USB standard.

In some embodiments, the host supports a plurality of data rates and the peripheral supports one or more of the plurality of data rates. Accordingly, the data rate of the wireless data link may be the same as or different than the data rate that the host and peripheral are attempting to communicate. Thus, in some embodiments, the wireless data rate is the same as one of the plurality of supported data rates, whereas in other embodiments, the wireless data rate is different that any of the supported data rates of the host and the peripheral. For example, consider (1) a host data rate as the rate of communication between the host and the wireless hub device, (2) a peripheral data rate as the rate of communication between the peripheral and the wireless peripheral device and (3) a wireless data rate as the data rate between the wireless hub device and the wireless peripheral device. In some embodiments, the host data rate and the peripheral data rate are different than the wireless data rate (e.g., host and peripheral are at HS and the wireless rate is at FS+, see FIG. 2). In some embodiments, the host data rate and the peripheral data rate are different than the wireless data rate (e.g., host is HS and the peripheral is FS, see FIG. 2). In some embodiments, the host data rate, the peripheral data rate and the wireless rate are different (e.g., host is HS and the peripheral is FS and the wireless data rate is FS+, see FIG. 2). Furthermore, in some embodiments, the wireless data rate varies over time.

Next, a flow of data between a host and the wireless hub device is controlled so that the host is unaware of the wireless data link, where the data is to be communicated between the host and the peripheral (STEP 1230). For example, in some embodiments, the wireless hub device emulates the peripheral from the perspective of the host. This control of the flow of data is done to ensure that the host maintains the communication link, for example in order to accommodate a wireless data link having a data rate that is different than (e.g., slower than) the expected wired data rate had the host been directly connected to a peripheral by a wireline connection. Additionally, the flow of data is controlled so that the host will maintain the link to account for error handling and re-transmissions that may be needed with the wireless data links.

The flow of data may be controlled in any of the ways described herein. For example, in some embodiments, the wireless hub device transmits signaling to the host to ensure that the communication link is maintained by the host and to maintain the transparency of the wireless protocol from the perspective of the host. For example, this signaling may include a negative acknowledgment (NAK), a packet error message, and/or a cyclic redundancy checking message. In some embodiments, transmitting such signaling to control the flow occurs in the event an expected data transmission from the peripheral to the host will not be received at the host within an allotted time period of the host. In some embodiments, the sending of signals to the host PC for one or more of the purposes described above may be referred as to spoofing the host PC. In some embodiments, similar to the control of the flow of data between the host and the wireless hub device, the flow of data is controlled between the peripheral wireless device and the peripheral as needed so that the peripheral is unaware of the wireless data link, i.e., the wireless peripheral device 203, 204, 205 emulates a host from the perspective of the peripheral.

Presented below is exemplary pseudo-code for implementing the wireless hub device and wireless peripheral device functionality according to one embodiment. This example is not meant to be limiting and is merely sample pseudo code for one embodiment. The pseudo-code is written in a modular fashion with common and well understood “C” like syntax. The pseudo-code's body is broken into snippets that are labeled. Each snippet starts with an “if—then” statement specifying set of actions taken upon receiving various USB tokens, USB transactions, and Control Transfer Requests.

The listing shown below contains exemplary pseudo-code for a state machine of a HS Hub with wireless functionality according to one embodiment. The state machine is divided into three parts: (i) handling tokens (IN, OUT, PING, SETUP and SOF); (ii) handling split transactions (SSPLIT, CSPLIT) (iii) handling control transfer request (RESET, SUSPEND, RESUME). Data is buffered along with other pertinent transaction details to deal with slow or broken wireless links and unresponsive peripheral devices; (ii) The buffer management module manages the buffers (allocating and de-allocating) by maintaining buffer state information and providing status information; (iii) If buffer space is unavailable, no action is taken and the transaction times out.

```
//HUB PROTOCOL ENGINE PSEUDO-CODE
  //TOKENS (IN, OUT, PING, SETUP, SOF)
  If (token == IN) then {
  Store the token and related details in the Buffer;
  Send the token and related details to the DEVICE;
  Maintain state information related to the transaction;
  While (1)
    If (data received from the DEVICE is available){
      Send data to the HOST;
      Update state information to indicate result received;
      Break;
    }
    Else {
      Send a 512 B junk data packet with arbitrary data and a CRC 16
      error to the HOST up to 2 times.  If (arbitrary data packet sent
      twice) send NAK to HOST; Update state information;
    }
  }
  If (token == OUT) then {
  Store the token and related details in the Buffer;
  Send the token and related details to the DEVICE;
  Maintain state information related to the transaction;
  While (1)
    If (ACK from the DEVICE is available){
      Send ACK to the HOST;
      Update state information to indicate result received;
      Break;
    }
    Else {
      Send a corrupted ACK packet (with PID error) to the HOST up to
      2 times.  If (corrupted ACK sent twice) send NAK to HOST;
      Update state information;
    }
  }
  If (token == PING) then {
  Store the token and related details in the Buffer;
  Send the token and related details to the DEVICE;
  Maintain state information related to the transaction;
  While (1)
    If (ACK from the DEVICE is available){
      Send ACK to the HOST;
      Update state information to indicate result received;
      Break;
    }
    Else {
      Send a corrupted ACK packet (with PID error) to the HOST up to
      2 times.  If (corrupted ACK sent twice) send NAK to HOST;
      Update state information;
  If (token == SETUP) then {
  Store the token and related details in the Buffer;
  Send the token and related details to the DEVICE;
  Maintain state information related to the transaction;
  While (1)
    If (ACK received from the DEVICE is available){
      Send ACK to the HOST;
      Update state information to indicate result received;
      Break;
    }
    Else {
      Send a corrupted ACK packet (with PID error) to the HOST up to
      2 times.  If (corrupted ACK sent twice) send ACK to HOST;
      Update state information;
      Break;
    }
  }
  If (token == SOF) then {
  Option 1: Keep track of time period (Tsof) between multiple SOFs.
      Update the value of Tsof regularly. Forward the SOF
      packets periodically along with the time period information
      to the DEVICE. The DEVICE periodically regenerates SOFs
      locally with the same time period information for the Peripheral.
      This may be used to reduce sending SOFs wireless repeatedly
      and also useful to keep the peripheral synchronized when the
      wireless link quality is poor.
  Option 2; Forward SOFs always to the DEVICE. Send the token and
      related details to the DEVICE. Maintain state information
      related to the transaction.
  //SSPLIT AND CSPLIT TRANSACTIONS
  If (transaction == SSPLIT/IN) then {
  Store the transaction details in the appropriate SSPLIT buffer;
  Send the transaction related details to the DEVICE;
  Maintain state information related to the transaction;
  While (1)
    If (data received from the DEVICE) {
      Store the appropriate data in the CSPLIT buffer;
      Update state information to indicate result received;
      Break;
    }
  }
  If (transaction == SSPLIT/OUT) then {
  Store the transaction details in the appropriate SSPLIT buffer;
  Send the transaction related details to the DEVICE;
  Maintain state information related to the transaction;
  While (1)
    If (response received from the DEVICE){
      Store the appropriate data in the CSPLIT buffer;
      Update state information to indicate result received;
      Break;
    }
  }
  If (transaction == CSPLIT/IN) then {
  Maintain state data related to the transaction;
  While (1)
    If (data received from the DEVICE){
      Send the data to the host after retrieving it from the CSPLIT
      buffer.
      Update state information to indicate result received;
      Break;
    Else{
      Return NYET response to the HOST;
      Update state information to indicate result not yet received;
    }
  }
  If (transaction == CSPLIT/OUT) then {
  Maintain state data related to the transaction;
  While (1)
    If (data received from the DEVICE){
      Send the data to the host after retrieving it from the CSPLIT
      buffer.
      Update state information to indicate result received;
      Break;
    Else{
      Return NYET response to the HOST;
      Update state information to indicate result not yet received;
    }
  }
  //CONTROL TRANSFER REQUEST (RESET, SUSPEND, RESUME)
  If (control transfer request == RESET) then {
  Store the transaction details and the related details in the Buffer;
  Send the control transfer request and related details to the DEVICE;
  Maintain state information related to the transaction;
  While (1)
    If (response received from the Peripheral){
      Update port change status register to reflect response received;
      Update stat information;
      Break;
    }
  }
  If (control transfer request == RESUME) then {
  Store the transaction details and the related details in the Buffer;
  Send the control transfer request and related details to the DEVICE;
  Maintain state information related to the transaction;
  While (1)
    If (response received from the Peripheral){
      Update port change status register to reflect response received;
      Update state information;
      Break;
    }
  }
  If (control transfer request == SUSPEND) then {
  Store the transaction details and the related details in the Buffer;
  Send the control transfer request and related details to the DEVICE;
  Maintain state information related to the transaction;
  While (1)
    If (response received from the Peripheral){
      Update port change status register to reflect response received;
      Update state information;
      Break;
    }
  }
```

The listing shown below contains pseudo code for a state machine for a wireless device according to one embodiment. The state machine is divided into three parts: (i) handling tokens (IN, OUT, PING, SETUP and SOF) (ii) handling split transactions (SSPLIT, CSPLIT) (iii) handling control transfer request (RESET, SUSPEND, RESUME). The data is buffered along with other pertinent transaction details to deal with slow or broken wireless links and unresponsive Peripherals. The buffer management module is responsible for managing the buffers (allocating and de-allocating), maintaining buffer state information and providing status information; If buffer space is unavailable, no action is taken and the transaction times out; The Peripheral referred to below is the Peripheral addressed in the transaction.

```
//DEVICE PROTOCOL ENGINE PSEUDO-CODE
  //TOKENS (IN, OUT, PING, SETUP, SOF)
  If (token == IN) then {
  Store the token and related details in the Buffer;
  Send the token and related details to the Peripheral;
  Maintain state information related to the transaction;
  While (1)
    If (data received from the Peripheral){
      Store the data in the Buffer
      Send data to the HUB;
      Update state information;
      Break;
    }
  }
  If (token == OUT) then {
  Store the token and related details in the Buffer;
  Send the token and the related details to the Peripheral;
  Maintain state information related to the transaction;
  While (1)
    If (ACK received from the Peripheral){
      Send the ACK to the HUB;
      Update state information;
      Break;
    }
  }
  If (token == PING) then {
  Store the token and related details in the Buffer;
  Send the token and related details to the Peripheral;
  Maintain state information related to the transaction;
  While (1)
    If (ACK received from the Peripheral){
      Send ACK to the HUB;
      Update state information;
      Break;
    }
  }
  If (token == SETUP) then {
  Store the token and related details in the Buffer;
  Send the token and related details to the Peripheral;
  Maintain state information related to the transaction;
  While (1)
    If (ACK received from the Peripheral) {
      Send ACK to the HUB;
      Update state information;
      Break;
    }
  }
  If (token == SOF) then {
  Store the token and related details in the Buffer;
  If (Option 1: [See SOF token handling by the HUB] or wireless link is
      broken or poor quality) {
      Locally generate SOF packet based on the Tsof data received from
      the HUB and send the SOF packet to the Peripheral;
  }
  Else Send the SOF packet to the peripheral;
  Update state information related to the transaction;
  }
  //SSPLIT AND CSPLIT TRANSACTIONS
  If (transaction == SSPLIT/IN) then {
  Store the transaction and related details in the appropriate SSPLIT
  buffer;
  Send an IN token with related transaction data to the Peripheral;
  Maintain state information related to the transaction;
  While (1)
    If (data received from the Peripheral
      Store the appropriate data in the CSPLIT buffer;
      Send the data to the HUB;
      Update state information to indicate result received;
      Break;
    }
  }
  If (transaction == SSPLIT/OUT) then {
  Store the transaction details in the appropriate SSPLIT buffer;
  Send an OUT token with related transaction data to the Peripheral;
  Maintain state information related to the transaction;
  While (1)
    If (response received from the Peripheral){
      Send the appropriate data to the HUB;
      Update state information to indicate result received;
      Break;
    }
  }
  //CONTROL TRANSFER REQUEST (RESET, SUSPEND, RESUME)
  If (control transfer request == RESET) then {
  Store control transfer request and related details in the buffer;
  Locally generate RESET signal for the Peripheral;
  Maintain state information related to the transaction;
  While (1)
    If (response received from the Peripheral){
      Send the response to the HUB;
      Update state information to indicate response received;
      Break;
    }
  }
  If (control transfer request == RESUME) then {
  Store control transfer request and related details in the buffer;
  Locally generate RESUME signal for the Peripheral;
  Maintain state information related to the transaction;
  While (1)
    If (response received from the Peripheral){
      Send the response to the HUB;
      Update state information to indicate response received;
      Break;
    }
  }
  If (control transfer request == SUSPEND) then {
  Store control transfer request and related details in the buffer;
  Locally generate SUSPEND signal for the Peripheral;
  Maintain state information related to the transaction;
  While (1)
    If (response received from the Peripheral){
      Send the response to the HUB;
      Update state information to indicate response received;
      Break;
    }
  }
```

Some exemplary applications of the disclosed invention include office and consumer entertainment products. Other applications include cable replacement of wired systems such as control systems found in industry (e.g. computer numerical controlled machinery) or at home (e.g. thermostat control). Other examples of applications may be found in automobiles and aircraft (e.g. avionics control systems and networking applications such as passenger e-mail). Embodiments of the method and apparatus disclosed have configurations and components suitable for a wide range of products that have a variety of latency, performance, and cost requirements.

Modules may also be implemented in software for execution by various types of processors. An identified module of executable code may, for instance, comprise one or more physical or logical blocks of computer instructions that may, for instance, be organized as an object, procedure, or function.

While the invention herein disclosed has been described by means of specific embodiments, examples and applications thereof, numerous modifications and variations could be made thereto by those skilled in the art without departing from the scope of the invention set forth in the claims.

What is claimed is:

1. A method of communicating between a host and a peripheral comprising:
establishing, in a manner transparent to the host, a wireless data link between a wireless hub device and a wireless peripheral device coupled to the peripheral, the wireless hub device coupled to and configured to communicate with the host, wherein the host is configured to communicate with peripheral devices over a wireline link at a plurality of data rates when connected via the wireline link; and
controlling a flow of data between the host and the wireless hub device so that the host is unaware of the wireless data link, wherein the data is to be communicated between the host and the peripheral.

2. The method of claim 1 wherein the host and the peripheral are configured to communicate with each other over the wireline link when connected to each other via the wireline link;
wherein the establishing step comprises:
establishing, in a manner transparent to the host and the peripheral, the wireless data link between the wireless hub device and the wireless peripheral device, the wireless peripheral device is configured to communicate with the peripheral; and
wherein the controlling step comprises:
controlling the flow of data between the host and the peripheral so that the host and the peripheral are unaware of the wireless data link.

3. The method of claim 1 wherein the controlling the flow step comprises:
transmitting a signal from the wireless hub device to the host to ensure that the host maintains communications with the wireless hub device.

4. The method of claim 3 wherein the transmitting the signal step occurs in the event an expected data transmission from the peripheral to the host will not be received at the host within an allotted time period of the host.

5. The method of claim 3 wherein the transmitting the signal comprises transmitting one or more of a negative acknowledgement, a packet error message or a cyclic redundancy checking (CRC) message.

6. The method of claim 1 wherein the controlling the flow step comprises:
spoofing the host to ensure that the host maintains communications with the wireless hub device.

7. The method of claim 1 wherein the controlling the flow step comprises controlling the flow of the data from the wireless hub device to the host so that the flow of the data to the host is according to one of the plurality of data rates.

8. The method of claim 1 wherein the controlling the flow step comprises controlling the flow of the data between the host and the peripheral to account for re-transmitting one or more communications over the wireless data link.

9. The method of claim 1 further comprising:
communicating between the wireless hub device and the wireless peripheral device at a data rate different than the plurality of data rates.

10. The method of claim 1, further comprising:
communicating between the wireless hub device and the host at one of the plurality of data rates.

11. The method of claim 1 further comprising:
communicating between the host and the wireless hub device at a first data rate, the first data rate being one of the plurality of data rates,
communicating between the peripheral and the wireless peripheral device at a second data rate, the second data rate being one of the plurality of data rates; and
communicating between the wireless hub device and the wireless peripheral device at a third data rate.

12. The method of claim 11 wherein both the first data rate and the second data rate are different than the third data rate.

13. The method of claim 11 wherein the first data rate and the second data rate are different.

14. The method of claim 11 wherein the first data rate, the second data rate and the third data rate are different.

15. The method of claim 14 wherein the third data rate is between the first data rate and the second data rate.

16. The method of claim 11 wherein the plurality of data rates correspond to data rates according to a communication protocol standard.

17. The method of claim 11 wherein the plurality of data rates correspond to data rates of the universal serial bus (USB) standard.

18. The method of claim 1 wherein the wireless data link is adapted to communicate signaling having a bandwidth that is at least two percent of a center frequency of the signaling.

19. The method of claim 1 wherein the wireless data link is adapted to communicate signaling having a bandwidth that is at least ten percent of a center frequency of the signaling.

20. The method of claim 1 wherein the wireless data link is adapted to communicate signaling having a bandwidth that is at least twenty percent of a center frequency of the signaling.

21. The method of claim 1 further comprising:
establishing, in a manner transparent to the host, a second wireless data link between the wireless hub device and a second wireless peripheral device coupled to a second peripheral.

22. The method of claim 1 wherein in the step of establishing the wireless data link, wherein a rate of the wireless data link varies in time.

23. The method of claim 1 wherein the host and the wireless hub device comprise separate devices contained within separate housings.

24. The method of claim 1 wherein the host and the wireless hub device are integrated into a housing.

25. The method of claim 1 wherein the wireless peripheral device and the peripheral comprise separate devices contained within separate housings.

26. The method of claim 1 wherein the wireless peripheral device and the peripheral are integrated into a housing.

27. The method of claim 1 wherein the host comprises a host controller adapted to control communications between the host and the peripheral devices over the wireline link when connected via the wireline link.

28. A communication system comprising:
a wireless hub device adapted to be coupled to a host and configured to communicate with the host, wherein the host is configured to communicate with peripheral devices over a wireline link at a plurality of data rates when connected via the wireline link;
a wireless peripheral device adapted to be coupled to a peripheral;
wherein the wireless hub device is adapted to:
establish, in a manner transparent to the host, a wireless data link between the wireless hub device and the wireless peripheral device; and
control a flow of data between the host and the wireless hub device so that the host is unaware of the wireless data link, wherein the data is to be communicated between the host and the peripheral.

29. The system of claim 28 wherein the host and the peripheral are configured to communicate with each other over the wireline link when connected to each other via the wireline link, wherein the wireless peripheral device is configured to communicate with the peripheral;
wherein the wireless hub device is adapted to establish, in a manner transparent to the host and the peripheral, the wireless data link between the wireless hub device and the wireless peripheral device; and
wherein the wireless hub device and the wireless peripheral device are adapted to control the flow of data between the host and the peripheral so that the host and the peripheral are unaware of the wireless data link.

30. The system of claim 28 wherein the wireless hub device is adapted to control the flow by transmitting a signal from the wireless hub device to the host to ensure that the host maintains communications with the wireless hub device.

31. The system of claim 30 wherein the wireless hub device is adapted to control the flow by transmitting the signal in the event an expected data transmission from the peripheral to the host will not be received at the host within an allotted time period of the host.

32. The system of claims 30 wherein the wireless hub device is adapted to control the flow by transmitting one or more of a negative acknowledgement, a packet error message or a cyclic redundancy checking message.

33. The system of claim 28 wherein the wireless hub device is adapted to control the flow by spoofing the host to ensure that the host maintains communications with the wireless hub device.

34. The system of claim 28 wherein the wireless hub device is adapted to control the flow of the data from the wireless hub device to the host so that the flow of the data to the host is according to one of the plurality of data rates.

35. The system of claim 28 wherein the wireless hub device is adapted to control the flow of the data between the host and the peripheral to account for re-transmitting one or more communications over the wireless data link.

36. The system of claim 28 wherein the wireless hub device and the wireless peripheral device are adapted to communicate therebetween at a data rate different than the plurality of data rates.

37. The system of claim 28 wherein the wireless hub device and the wireless peripheral device are adapted to communicate therebetween at one of the plurality of data rates.

38. The system of claim 28,
wherein the host and the wireless hub device are adapted to communicate therebetween at a first data rate, the first data rate being one of the plurality of data rates,
wherein the peripheral and the wireless peripheral device are adapted to communicate therebetween at a second data rate, the second data rate being one of the plurality of data rates; and
wherein the wireless hub device and the wireless peripheral device are adapted to communicate therebetween at a third data rate.

39. The system of claim 38 wherein both the first data rate and the second data rate are different than the third data rate.

40. The system of claim 38 wherein the first data rate and the second data rate are different.

41. The system of claim 38 wherein the first data rate, the second data rate and the third data rate are different.

42. The system of claim 41 wherein the third data rate is between the first data rate and the second data rate.

43. The system of claim 28 wherein the plurality of data rates correspond to data rates according to a communication protocol standard.

44. The system of claim 28 wherein the plurality of data rates correspond to data rates of the universal serial bus (USB) standard.

45. The system of claim 28 wherein the wireless hub device and the wireless peripheral device are each adapted to communicate using signaling having a bandwidth that is at least two percent of a center frequency of the signaling.

46. The system of claim 28 wherein the wireless hub device and the wireless peripheral device are each adapted to communicate using signaling having a bandwidth that is at least ten percent of a center frequency of the signaling.

47. The system of claim 28 wherein the wireless hub device and the wireless peripheral device are each adapted to communicate using signaling having a bandwidth that is at least twenty percent of a center frequency of the signaling.

48. The system of claim 28 wherein the wireless hub device is adapted to establish, in a manner transparent to the host, a second wireless data link between the wireless hub device and a second wireless peripheral device coupled to a second peripheral.

49. The system of claim 28 wherein the wireless hub device is adapted to establish the wireless data link, wherein a rate of the wireless data link varies in time.

50. The system of claim 28 further comprising:
a first housing containing the host; and
a second housing separate from the first housing and containing the wireless hub device.

51. The system of claim 28 further comprising a first housing containing the host and the wireless hub device.

52. The system of claim 28 further comprising:
a first housing containing the wireless peripheral device; and
a second housing separate from the first housing and containing the peripheral.

53. The system of claim 28 further comprising a first housing containing the wireless peripheral device and the peripheral.

54. The system of claim 28 wherein the host comprises a host controller adapted to control communications between the host and the peripheral devices over the wireline link when connected via the wireline link.

55. A communication system including a host and a peripheral comprising:
means for establishing, in a manner transparent to the host, a wireless data link between a wireless hub device and a wireless peripheral device coupled to the peripheral, the wireless hub device coupled to and configured to communicate with the host, wherein the host is configured to communicate with peripheral devices over a wireline link at a plurality of data rates when connected via the wireline link; and
means for controlling a flow of data between the host and the wireless hub device so that the host is unaware of the wireless data link, wherein the data is to be communicated between the host and the peripheral.
